(19) United States
(12) Patent Application Publication
(10) Pub. No.: US 2025/0206866 A1
(43) Pub. Date: Jun. 26, 2025

(54) METHODS FOR PRODUCING VINYLAMINE-CONTAINING POLYMER SOLUTIONS AND VINYLAMINE-CONTAINING POLYMER SOLUTIONS PRODUCED THROUGH THE METHODS

(71) Applicant: SOLENIS TECHNOLOGIES, L.P., Wilmington, DE (US)

(72) Inventors: Sachin Borkar, Wilmington, DE (US); Richard J. Riehle, Wilmington, DE (US)

(73) Assignee: SOLENIS TECHNOLOGIES, L.P., Wilmington, DE (US)

(21) Appl. No.: 18/976,603

(22) Filed: Dec. 11, 2024

Related U.S. Application Data
(60) Provisional application No. 63/613,825, filed on Dec. 22, 2023.

(51) Int. Cl. C08F 226/02; C08F 220/54

(52) U.S. Cl. CPC C08F 226/02; C08F 220/54; C08F 2400/02

(57) ABSTRACT

Methods for producing a vinylamine-containing polymer solution and vinylamine-containing polymer solutions produced through the methods are provided herein. In an embodiment, a method for producing a vinylamine-containing polymer solution includes polymerizing N-vinylcarboxamide monomers and hydrolyzing a resulting intermediate polymer formulation. The method involves determining the amount of unreacted N-vinylcarboxamide monomers in the intermediate polymer formulation, modifying one or more process parameters of the polymerization step accordingly, and repeating the polymerization step with the modified process parameter(s). Methods of assessing the amount of unreacted monomers include directly measuring the amount of unreacted monomers in the intermediate, observing the color of the product, measuring the wavelength of the product, or measuring the dynamic viscosity of the product.

### TECHNICAL FIELD

The present disclosure generally relates to polymer production, and more particularly relates to polymerization of N-vinylcarboxamide monomers.

### BACKGROUND

Vinylamine-containing polymers are synthetic polymers that contain vinylamine units in their chemical structure. Vinylamine-containing polymers are cationic in nature. They are also highly water soluble, which makes them suitable for use in aqueous solutions. Vinylamine-containing polymers are generally stable under a wide range of pH conditions, temperature, and exposure to oxygen. They can form films and coatings when applied to surfaces. These properties make vinylamine-containing polymers useful in various applications including papermaking, water treatment, and adhesives and coatings.

One example of a vinyl-amine containing polymer is polyvinylamine (PVAm). PVAm is a polymer having a high content of primary amine functional groups. As a result, PVAm can form hydrogen and/or covalent bonds with functional surfaces or molecules, and it readily creates derivatives. PVAm adsorbs on most surfaces in water, generating cationic interfaces which can form complexes with oppositely charged polymers or molecules, including negatively charged surfactants. PVAm is very hydrophilic. Because PVAm derivatives promote adhesion between wet or dry surfaces, PVAm is used as a papermaking additive.

The general processes for synthesizing vinylamine-containing polymers are known in the industry. In one process, first, N-vinylcarboxamide monomers are combined with a polymerization initiator to create an intermediate polymer formulation containing a poly(N-vinylcarboxamide) prepolymer.

After the polymerization step is completed, acid or base is added to the resulting intermediate polymer formulation to hydrolyze the poly(N-vinylcarboxamide) prepolymer and create a vinylamine-containing polymer solution which includes a vinylamine-containing polymer. The hydrolysis step converts carboxamide functions in the poly(N-vinylcarboxamide) prepolymer into vinylamine functions. Depending on various factors, the resulting vinylamine-containing polymer solution may contain an unacceptably high amount of impurities, resulting in an unacceptably high dynamic viscosity or gel formation. Gelling creates a product that is low quality, and such low quality vinylamine-containing polymer solution may be difficult to handle and use.

One example of an N-vinylcarboxamide monomer is a vinylformamide (VFA) monomer. If VFA monomers are used in the polymerization step described above, the intermediate polymer formulation will contain a polyvinylformamide (poly-VFA) prepolymer. Then, after the hydrolysis step is complete, the resulting vinylamine-containing polymer solution will contain a PVAm polymer. PVAm polymer solutions face the same problems described above that are faced by other vinylamine-containing polymer solutions.

To avoid some of the aforementioned problems, the known processes for producing vinylamine-containing polymer solutions are carried out under vacuum conditions or under inert atmosphere. However, while vacuum conditions and inert atmosphere are known to reduce impurity content in the vinylamine-containing polymer solution, it remains difficult to assess whether the resulting vinylamine-containing polymer solution has unacceptably high impurity content that may lead to poor performance (i.e., unacceptably high dynamic viscosity and/or gelling).

Accordingly, it is desirable to provide processes for producing vinylamine-containing polymer solutions that enable quality of the vinylamine-containing polymer solution to be assessed. More specifically, it is desirable to provide processes that enable identification of unacceptably high impurity content that leads to poor dynamic viscosity and/or gelling. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods for producing a vinylamine-containing polymer solution and vinylamine-containing polymer solutions produced through the methods are provided herein. In an embodiment, a method for producing a vinylamine-containing polymer solution includes polymerizing N-vinylcarboxamide monomers and hydrolyzing a resulting intermediate polymer formulation. The method involves determining the amount of unreacted N-vinylcarboxamide monomers in the intermediate polymer formulation, modifying one or more process parameters of the polymerization step accordingly, and repeating the polymerization step with the modified process parameter(s).

The method comprises the polymerization of a reaction mixture that includes a polymerization initiator and one or more N-vinylcarboxamide monomers of Formula I:

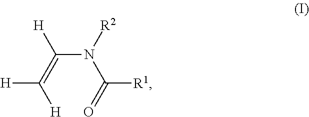

wherein R¹ and R², independently of one another, are H or C₁ to C₆ alkyl groups. Optionally, one or more vinyl monomers having a formula different from formula I may also be added to the reaction mixture. The polymerization step results in an intermediate polymer formulation which contains a poly(N-vinylcarboxamide) prepolymer. Carboxamide groups in the poly(N-vinylcarboxamide) prepolymer are hydrolyzed during a hydrolysis step, resulting in a vinylamine-containing polymer solution which contains a vinylamine-containing polymer.

In accordance with the methods contemplated herein, it is determined that the intermediate polymer formulation contains an unacceptably high amount of unreacted N-vinylcarboxamide monomers. After this determination is made, one or more process parameters of the polymerization step are modified, and the polymerization step is repeated with the modified process parameters to form a modified intermediate polymer formulation.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

The methods as provided herein enable production of a vinylamine-containing polymer solution which contains minimal unreacted N-vinylcarboxamide monomers and thus has an acceptably low dynamic viscosity and is resistant to gelling and mixing issues. More specifically, degree of polymerization of N-vinylcarboxamide monomers is an important factor during preparation of a vinylamine-containing polymer solution through conventional unit operations (e.g., reaction of N-vinylcarboxamide monomers and a polymerization initiator in a reaction mixture to form an intermediate polymer formulation containing a poly(N-vinylcarboxamide) prepolymer followed by intentional hydrolysis of carboxamide groups in the poly(N-vinylcarboxamide) prepolymer to form the vinylamine-containing polymer solution).

Some residual N-vinylcarboxamide monomers may remain in the intermediate polymer formulation after the polymerization step. Further, some of the N-vinylcarboxamide may be unintentionally hydrolyzed before or during the polymerization step, forming byproducts such as acetaldehyde and reaction products thereof. Such byproducts are polymerization inhibitors, which may further inhibit the polymerization of the remaining N-vinylcarboxamide monomers. Any residual N-vinylcarboxamide, acetaldehyde, or other byproducts present after the polymerization step may cause problems during downstream process steps, such as a hydrolysis step. It has been found that the amount of unreacted N-vinylcarboxamide present after the polymerization step but before the hydrolysis step is correlated with the color, dynamic viscosity, crosslinking, and occurrence of gelling in the vinylamine-containing polymer solution after the hydrolysis step. Accordingly, it is desirable to minimize the amount of unreacted N-vinylcarboxamide present in the intermediate polymer formulation in order to improve the quality of the vinylamine-containing polymer solution.

In accordance with the methods as provided herein, various approaches may be employed to determine that an intermediate polymer formulation containing a poly(N-vinylcarboxamide) prepolymer, i.e., an intermediate polymerization product of vinylcarboxamide after reacting the one or more N-vinylcarboxamide monomers and a polymerization initiator in the reaction mixture but prior to further processing such as a hydrolysis step, has an unacceptably high amount of unreacted N-vinylcarboxamide monomers (including residual N-vinylcarboxamide monomers and their byproducts, such as aldehydes and ketones). One approach is to directly measure the amount of unreacted N-vinylcarboxamide in the intermediate polymer formulation. It has also been found that the color of the vinylamine-containing polymer solution correlates to content of unreacted N-vinylcarboxamide monomers in the intermediate polymer formulation. Accordingly, another approach for determining that the intermediate polymer formulation contains an unacceptably high amount of unreacted N-vinylcarboxamide monomers is to observe the color of the vinylamine-containing polymer solution and compare it to an acceptable color. The wavelength of the vinylamine-containing polymer solution may also be measured and compared to a predetermined threshold wavelength value for an acceptable vinylamine-containing polymer solution. Another approach for determining that the intermediate polymer formulation contains an unacceptably high amount of unreacted N-vinylcarboxamide monomers is to measure the dynamic viscosity of the vinylamine-containing polymer solution and compare it to a predetermined threshold dynamic viscosity value required for an acceptable vinylamine-containing polymer solution. Based on the determination of the intermediate polymer formulation to contain an unacceptably high amount of unreacted N-vinylcarboxamide monomers, one or more process parameters may be modified, and the polymerization step may be repeated with a new batch of monomers to form a modified intermediate polymer formulation. The process parameter modification and repetition of the polymerization step with a new batch of monomers may be repeated until a desired content of unreacted N-vinylcarboxamide in the intermediate polymer formulation is achieved.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The methods as provided herein incorporate a process of producing a vinylamine-containing polymer solution which comprises a vinylamine-containing polymer. The process involves a “polymerization step,” which is defined as the overt step of combining a polymerization initiator and one or more N-vinylcarboxamide monomers, and optionally one or more other vinyl monomers, under reaction conditions to form an intermediate polymer formulation comprising a poly(N-vinylcarboxamide) prepolymer. Polymerization of residual monomers, impurities, or unintentional reaction products of monomers may also occur incidentally before the polymerization step. This incidental polymerization is not considered part of the “polymerization step.”

The process also involves a “hydrolysis step,” which is defined as the overt step of intentionally hydrolyzing functional groups in the poly(N-vinylcarboxamide) prepolymer to form a vinylamine-containing polymer solution comprising a vinylamine-containing polymer. Hydrolysis of monomers, polymers, and other compounds that are present may also occur before the hydrolysis step. This incidental hydrolysis is not considered part of the “hydrolysis step.”

The methods as provided herein represent an improvement to the synthesis of vinylamine-containing polymers by implementing modification or repetition of process steps based on a measurement or observation of the intermediate polymer formulation (after the polymerization step) or of the vinylamine-containing polymer solution (after the hydrolysis step). Modification or repetition of appropriate process steps results in a vinylamine-containing polymer solution with fewer impurities and more desirable properties.

The methods as contemplated herein involve first completing one or more process steps of a known process for producing a vinylamine-containing polymer solution. In the first step, which is a polymerization step, one or more N-vinylcarboxamide monomers is provided having the formula I:

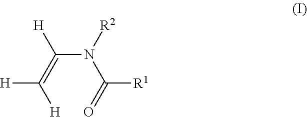

wherein R¹ and R², independently of one another, are H or C₁ to C₆ alkyl groups. The monomer(s) of formula I are combined with a polymerization initiator in a reaction mixture under appropriate reaction conditions to effectuate a polymerization reaction.

Various vinylcarboxamide monomers having formula I may be employed in accordance with the present disclosure. For example, in some embodiments, if R¹ and R² are both H, then the N-vinylcarboxamide monomer of formula I is N-vinylformamide. In other embodiments, if R¹ and R² are both methyl groups, then the N-vinylcarboxamide monomer having the formula I is N-vinyl-N-methylacetamide. In still other embodiments, R¹ and R² may be two different functional groups. Other examples of N-vinylcarboxamide monomers include but are not limited to N-vinyl-N-methylformamide, N-vinylacetamide, N-vinyl-N-ethylacetamide, N-vinylpropionamide, N-vinyl-N-methyl-propionamide, and N-vinylbutyramide. One or more variations of monomers having formula I are reactants in the claimed methods.

In some embodiments, one or more vinyl monomers of a formula different from formula I may also be reactants. “Vinyl monomer(s)” refers to monomer(s) which have (H₂C═C—) group in their structure. Vinyl monomers could alternatively be defined as ethylenically unsaturated monomers. Examples of suitable vinyl monomers having a formula different from formula I include, but are not limited to, N-vinylpyrrolidone, acrylamide, acrylic acid, vinyl acetate, methyl acrylate, or combinations thereof. Additional examples include, but are not limited to, methacrylamide, N-isopropylacrylamide, N-methylmethacrylamide, acrylonitrile, vinyl chloride, styrene, methacrylic acid, acid, maleic acid, itaconic acid, vinylphosphonic acid, vinylsulfonic diallyldimethylammonium chloride (DADMAC), acrylamidopropyltrimethyl ammonium chloride (APTAC), methacrylamidopropyltrimethyl ammonium chloride, or combinations thereof. Any combination of the aforementioned monomers may be used.

The polymerization initiator may be a non-oxidizing radical initiator, such as an azo compound. Examples of azo initiators include, but are not limited to, 2,2′-azobis(2-methylpropionamidine) dihydrochloride (which is available commercially from FUJIFILM Wako Chemicals USA, Corp. the trade name V-50) 2,2′-azobis(2-amidinopropane) dihydrochloride, 2,2′-azobis(N,N′-dimethyleneisobutyramidine) dihydrochloride, 2,2′-azobis[2-methyl-N-(2-hydroxyethyl)-propionamide], azo-bis-isobutyronitrile, 4,4′-azobis(4-cyanovaleric acid), 2,2′-azobis[2-(2-imidazolin-2-yl) propane]dihydrochloride, 2,2′-azobis[N-(2-carboxyethyl)-2-methylpropionamidine]tetrahydrate, or 2-2′-azobis(2-methyl-butyronitrile). In other embodiments, the polymerization initiator may be hydrogen peroxide, alkali metal or ammonium salts of peroxydisulfuric acid, peroxides, hydroperoxides, or redox catalysts. In some embodiments, the polymerization initiator may be used in an amount from about 0.01 to about 5% by weight, based on the total weight of the reaction mixture.

The reaction mixture may be an aqueous solution of at least about 30% monomers by weight based on the total weight of the reaction mixture. The concentration of the monomers in the aqueous solution may be up to about 90% by weight, alternatively from about 60% to about 85% by weight, based on the total weight of the reaction mixture.

The reaction mixture may be buffered to a pH of from about 5 to about 8, alternatively from about 6 to about 7. To stabilize the pH during the polymerization step, the polymerization step may be carried out in the presence of a conventional buffer system.

The polymerization step may also be carried out under an inert gas, such as nitrogen, or under vacuum. In other embodiments, the polymerization step may be carried out with evaporative cooling at from 20 mbar to atmospheric pressure and a temperature in the reaction mixture of less than about 100° C., alternatively from about 25° C. to about 80° C.

In some embodiments, the polymerization step may be carried out in a mixing apparatus in which the reactants can be thoroughly mixed. For example, the polymerization step may be carried out in a single-screw kneader or an extruder. The solids content of the reaction mixture during the polymerization step may be from about 30% to about 90% by weight, alternatively from about 60% to about 85% by weight, based on the total weight of the reaction mixture.

After the polymerization step, in some embodiments, the conversion of the monomers into a polymer may be at least 75 mol %, based on the total moles of monomers present in the reaction mixture prior to polymerization. In other embodiments, the conversion of monomers into a polymer may be lower than 75 mol %, based on the total moles of monomers present in the reaction mixture prior to polymerization. The conversion rate of the monomers may be improved through the methods described herein.

After the polymerization step has been completed, an intermediate polymer formulation has been formed. As used herein, an intermediate polymer formulation is defined as a polymer formulation which contains a poly(N-vinylcarboxamide) prepolymer. The intermediate polymer formulation may also contain other polymers, unreacted N-vinylcarboxamide monomers, residual polymerization initiator, or other byproducts or impurities. A poly(N-vinylcarboxamide) prepolymer is defined as a poly(N-vinylcarboxamide) polymer which has been formed through a polymerization step but has not yet been intentionally hydrolyzed, through addition of acid or base, to form a vinylamine-containing polymer solution. The poly(N-vinylcarboxamide) prepolymer may be a homopolymer or a copolymer and may contain non-vinylcarboxamide units derived from one or more vinyl monomers of a formula different from formula I as described above. In an embodiment, the N-vinylcarboxamide monomer reacted in the polymerization step is N-vinylformamide and the poly(N-vinylcarboxamide) prepolymer is a polyvinylformamide polymer. In some embodiments of the method, the poly(N-vinylcarboxamide) prepolymer has a molecular weight in the range of from about 5,000 Daltons to about 5,000,000 Daltons.

As previously described, the intermediate polymer formulation containing poly(N-vinylcarboxamide) prepolymer is the intermediate product in a method of forming a vinylamine-containing polymer solution. As used herein, unreacted N-vinylcarboxamide monomers are defined as N-vinylcarboxamide monomers which were combined with a polymerization initiator in a reaction mixture, but did not react to form the poly(N-vinylcarboxamide) prepolymer, and remain as either monomers or side-reaction products in the intermediate polymer formulation. Side reaction products covered by this definition may include hydrolysis products of N-vinylcarboxamide monomers, such as acetaldehyde or ketones.

The degree of polymerization of monomers during the polymerization step is an important factor that affects properties of the resulting vinylamine-containing polymer solution. Any residual N-vinylcarboxamide monomers, or byproducts thereof, present after the polymerization step may cause problems during the downstream process steps, such as a hydrolysis step.

The methods as provided herein also include a hydrolysis step in which the poly(N-vinylcarboxamide) prepolymer contained in the intermediate polymer formulation is hydrolyzed to produce the vinylamine-containing polymer solution including vinylamine-containing polymer.

In some embodiments, a scavenger to quench the effect of unreacted N-vinylcarboxamide monomers may be added to the reaction mixture before the hydrolysis step in an amount of from about 0.01 wt % to about 10 wt %, alternatively from about 0.5 wt % to about 5 wt %, relative to the total weight of vinyl monomers in the reaction mixture.

In some embodiments, the hydrolysis step includes hydrolyzing the poly(N-vinylcarboxamide) prepolymer in the intermediate polymer formulation by adding one or more acids or bases to produce a vinylamine-containing polymer solution including vinylamine-containing polymer. Examples of acids which may be used for the hydrolysis step include mineral acids or organic acids. Examples of bases which may be used for the hydrolysis step include lithium hydroxide, sodium hydroxide, potassium hydroxide, calcium hydroxide, strontium hydroxide, and/or barium hydroxide.

In some embodiments, the acid or base may be added to the reaction mixture in the hydrolysis step in an amount of from about 0.05 to about 1.5, alternatively from about 0.4 to about 1.2, equivalents of base or acid per equivalent of formyl groups in the polymer.

The hydrolysis step may be carried out at a temperature in the reaction mixture of from about 20° C. to about 100° C., alternatively from about 40° C. to about 70° C.

As used herein, a vinylamine-containing polymer is defined as a polymer containing vinylamine functional groups, which has been formed through a polymerization step and a hydrolysis step. The vinylamine-containing polymer may be a homopolymer or a copolymer and may contain non-vinylamine units. A vinylamine-containing polymer solution is defined as a polymer formulation which contains at least a vinylamine-containing polymer. It may also contain other polymers, unreacted N-vinylcarboxamide monomers, unreacted vinyl monomers having a formula different from formula I, residual polymerization initiator, or other byproducts or impurities. Notably, residual N-vinylcarboxamide monomers or their hydrolysis products may still be present in the vinylamine-containing polymer solution.

After the hydrolysis step has been completed, the resulting vinylamine-containing polymer may be the result of either complete hydrolysis of the poly(N-vinylcarboxamide) prepolymer or partial hydrolysis of the poly(N-vinylcarboxamide) prepolymer. In an embodiment, if complete hydrolysis has occurred, then substantially every carboxamide moiety contained in the poly(N-vinylcarboxamide) prepolymer has been hydrolyzed to form the resulting vinylamine-containing polymer. This may result in either a vinylamine homopolymer or a vinylamine copolymer containing hydrolysis products of the carboxamide moieties present in the prepolymer.

In other embodiments, complete hydrolysis may not have occurred. The degree of hydrolysis of the carboxamide moieties contained in the poly(N-vinylcarboxamide) prepolymer may be from about 0.1 mol % to less than about 99 mol %, alternatively from about 10 mol % to about 90 mol %, alternatively from about 40 mol % to about 80 mol %, alternatively from about 60 mol % to about 70 mol %, based on the total moles of carboxamide moieties in the prepolymer.

In addition to the vinylamine-containing homopolymer or copolymer, the vinylamine-containing polymer solution may contain other polymers, unreacted N-vinylcarboxamide monomers, other unreacted vinyl monomers, residual polymerization initiator, or other byproducts or impurities. Byproducts may include unintentional hydrolysis products of the monomers or products of other side reactions.

Accordingly, impurities in the intermediate polymer formulation may lead to problems during the hydrolysis step, which in turn may lead to a lower quality vinylamine-containing polymer solution. Specifically, it has been found that the presence of unreacted N-vinylcarboxamide monomers in the intermediate polymer formulation leads to a lower quality vinylamine-containing polymer solution after the hydrolysis step. Without being bound by any theory, this is thought to be a result of unintentional conversion of the unreacted N-vinylcarboxamide monomers to their hydrolysis byproducts during the hydrolysis step. The presence of these byproducts, and of residual non-polymerized and non-hydrolyzed N-vinylcarboxamide monomers may cause crosslinking of the vinylamine-containing polymer or other undesirable side reactions.

In order to improve the quality of the vinylamine-containing polymer solution, it is desirable to minimize the amount of unreacted N-vinylcarboxamide monomers in the intermediate polymer formulation. Accordingly, the methods provided herein provide a feedback loop in which the amount of unreacted N-vinylcarboxamide monomers present in the intermediate polymer formulation may be measured, either quantitatively or qualitatively, so that it can be determined whether the polymerization step needs to be modified and repeated with a new batch of monomers to reduce the amount of unreacted N-vinylcarboxamide monomers before the hydrolysis step is performed. In embodiments of the methods, certain characteristics of the vinylamine-containing polymer may be observed or measured in order to determine whether process parameters need to be modified in order to reduce the amount of unreacted N-vinylcarboxamide monomers present in the intermediate polymer formulation and thus improve the quality of the vinylamine-containing polymer solution.

As used in this disclosure, the term “unacceptably high” means that the measured value is greater than a threshold value. The term “acceptable” means that the measured value is not “unacceptably high,” or that the measured value is less than or equal to a threshold value. As it relates to measuring the amount of unreacted N-vinylcarboxamide monomers in the intermediate polymer formulation, a predetermined N-vinylcarboxamide threshold value has been defined as the weight percentage of N-vinylcarboxamide monomers present in the intermediate polymer formulation at or below which the resulting vinylamine-containing polymer solution is acceptable.

The methods are carried out by determining that the intermediate polymer formulation has an unacceptably high amount of unreacted N-vinylcarboxamide monomers, and using that information to modify one or more process parameters. In particular, the subject method relates to circumstances in which unacceptably high amounts of unreacted N-vinylcarboxamide monomers are present, as production of vinylamine-containing polymer solution having acceptably low amounts of unreacted N-vinylcarboxamide does not require modification of process parameters. In an embodiment, determining that the intermediate polymer formulation has an unacceptably high amount of unreacted N-vinylcarboxamide monomers involves directly measuring the amount of unreacted N-vinylcarboxamide monomers in the intermediate polymer formulation, after the polymerization step but before the hydrolysis step. The amount of unreacted N-vinylcarboxamide monomers may be measured by, for example, high performance liquid chromatography. After the amount of N-vinylcarboxamide monomers in the intermediate polymer formulation has been measured, then the amount is compared to the predetermined N-vinylcarboxamide threshold value. If the amount of unreacted N-vinylcarboxamide monomers is greater than the predetermined N-vinylcarboxamide threshold value, then the intermediate polymer formulation is determined to have an unacceptably high amount of unreacted N-vinylcarboxamide monomers.

In an embodiment, the predetermined N-vinylcarboxamide threshold value is 0.03% by weight, alternatively 0.05% by weight, alternatively 0.06% by weight. In other embodiments, the predetermined N-vinylcarboxamide threshold value may be 0.10%, 0.13%, 0.15%, 0.20%, or 0.25% by weight. In embodiments, the threshold value is from 0.13% to 0.9%.

Other methods of determining the intermediate polymer formulation to have an unacceptably high amount of unreacted N-vinylcarboxamide monomers may also be used. It has been found that characteristics of the vinylamine-containing polymer solution such as a visually observed color, a measured wavelength, and a dynamic viscosity of the vinylamine-containing polymer solution are correlated with the amount of unreacted N-vinylcarboxamide monomers which were present in the intermediate polymer formulation from which the vinylamine-containing polymer solution was formed. Accordingly, observing and/or measuring these characteristics allows a determination that the amount of unreacted N-vinylcarboxamide monomers is unacceptably high, and thus allows a modification of process parameters and the production of a higher quality vinylamine-containing polymer solution.

Additional threshold values are used in some embodiments of the method. As it relates to the visual color of the vinylamine-containing polymer solution, acceptable colors will be set forth herein that correlate to threshold values of unacceptably high amount of unreacted N-vinylcarboxamide monomers in the intermediate polymer formulation. As it relates to the wavelength of the vinylamine-containing polymer solution, a predetermined wavelength threshold value is defined as the wavelength of the vinylamine-containing polymer solution at or below which correlates to the intermediate polymer formulation containing an acceptable amount of unreacted N-vinylcarboxamide monomers. As it relates to the dynamic viscosity of the vinylamine-containing polymer solution, a predetermined dynamic viscosity threshold value is defined as the dynamic viscosity of the vinylamine-containing polymer solution at or below which correlates to the intermediate polymer formulation containing an acceptable amount of unreacted N-vinylcarboxamide monomers.

In an embodiment, after the polymerization step and the hydrolysis step have been completed, the color of the resulting vinylamine-containing polymer solution is visually observed. For example, if the color is visually determined to be dark yellow, amber or orange, or objectively measured to have a wavelength that visually correlates to dark yellow, amber, or orange, then this leads to a determination that there was an unacceptably high amount of unreacted N-vinylcarboxamide monomers in the intermediate polymer formulation from which the vinylamine-containing polymer solution was formed. If the color is objectively determined to be a color having a lower wavelength than dark yellow (e.g. light yellow or clear), then this leads to a determination that there was an acceptable amount of unreacted N-vinylcarboxamide monomers in the intermediate polymer formulation from which the vinylamine-containing polymer solution was formed.

In another embodiment, after the polymerization step and the hydrolysis step have been completed, the wavelength of the resulting vinylamine-containing polymer solution may be measured using a spectrophotometer. The wavelength of the vinylamine-containing polymer solution may then be compared to the predetermined wavelength threshold value. If the wavelength is greater than the predetermined wavelength threshold value, then this leads to a determination that there was an unacceptably high amount of unreacted N-vinylcarboxamide monomers in the intermediate polymer formulation from which the vinylamine-containing polymer solution was formed. If the wavelength is equal to or less than the predetermined wavelength threshold value, then this leads to a determination that there was an acceptable amount of unreacted N-vinylcarboxamide monomers in the intermediate polymer formulation from which the vinylamine-containing polymer solution was formed.

In an embodiment, the predetermined wavelength threshold value is about 600 nm, alternatively about 575 nm, alternatively from about 575 nm to about 600 nm.

In another embodiment, after the polymerization step and the hydrolysis step have been completed, the dynamic viscosity of the resulting vinylamine-containing polymer solution may be measured. The dynamic viscosity may be measured, for example, with total solids of 18% using a Brookfield viscometer at 6 rpm using an LV spindle number 62 at 25° C. The dynamic viscosity of the vinylamine-containing polymer solution may then be compared to the predetermined dynamic viscosity threshold value. If the dynamic viscosity is greater than the predetermined dynamic viscosity threshold value, then this leads to a determination that there was an unacceptably high amount of unreacted N-vinylcarboxamide monomers in the intermediate polymer formulation from which the vinylamine-containing polymer solution was formed. If the dynamic viscosity is equal to or less than the predetermined dynamic viscosity threshold value, then this leads to a determination that there was an acceptable amount of unreacted N-vinylcarboxamide monomers in the intermediate polymer formulation from which the vinylamine-containing polymer solution was formed.

In an embodiment, the predetermined dynamic viscosity threshold value is about 700 cPs. In other embodiments, the predetermined dynamic viscosity threshold value may be about 1000 cPs, alternatively about 1700 cPs, alternatively about 2000 cPs, alternatively from about 700 cPs to about 2000 cPs.

After it has been determined that the amount of unreacted N-vinylcarboxamide monomers in the intermediate polymer formulation is greater than the predetermined N-vinylcarboxamide threshold value (and thus is unacceptably high), one or more process parameters are modified, and the polymerization step is repeated with a new batch of monomers. The process parameters to be modified may include, for example, reaction time, temperature, pressure, pH, initiator concentration, monomer concentration, and/or purity of process water.

After the polymerization step has been repeated with the modified process parameter(s), then the amount of unreacted N-vinylcarboxamide monomers in the new intermediate polymer formulation may be measured again. If the amount of unreacted N-vinylcarboxamide monomers is still unacceptably high, then the process parameters may be further modified, and the polymerization step may be repeated again with a new batch of monomers to produce a new batch of the intermediate polymer formulation. This cycle may be continued until a measurement of the amount of unreacted N-vinylcarboxamide monomers in the intermediate polymer formulation is determined to be acceptable (at or below the predetermined N-vinylcarboxamide threshold value). Then, the intermediate polymer formulation is subjected to the hydrolysis step to form the vinylamine-containing polymer solution. The resulting vinylamine-containing polymer solution may have improved properties over a solution produced by simply completing the polymerization step and the hydrolysis step without measuring the amount of unreacted monomers as the processes contemplated herein allow for identification of substandard intermediate polymer formulations and enable appropriate remedial steps to be taken to yield a higher quality vinylamine-containing polymer solution.

The characteristics of the new batch of vinylamine-containing polymer solution, formed after modifying one or more of the process parameters of the polymerization step, may then be observed or measured. For example, the color may be visually observed, or the wavelength or dynamic viscosity may be measured. If the observed or measured characteristic is still above the relevant threshold value, this indicates that the amount of unreacted N-vinylcarboxamide in the intermediate polymer formulation is still unacceptably high. If this determination is made, then the process parameters for the polymerization step may be further modified, and the polymerization step and hydrolysis step may be repeated again with a new batch of monomers to produce a new batch of the intermediate polymer formulation. This cycle may be continued until an observation or measurement of a characteristic of the intermediate polymer formulation and/or the vinylamine-containing polymer yields a value at or below the relevant threshold value in accordance with the methodologies described above. When an acceptable amount of unreacted N-vinylcarboxamide in the intermediate polymer formulation is achieved, vinylamine-containing polymer solution may be produced for commercial use.

The resulting vinylamine-containing polymer solution formed through the aforementioned methods may have improved properties over a solution produced by simply completing the polymerization step and the hydrolysis step without measuring the characteristics of the intermediate polymer formulation and/or the resulting vinylamine-containing polymer solution and repeating modified process steps with a new batch of monomers as needed. Thus, the methods as contemplated herein lead to higher quality vinylamine-containing polymer solutions and allow for production of more acceptable solutions and therefore less waste.

The methods provided herein allow for the production of high quality vinylamine-containing polymer solutions, reducing instances of gelling. This leads to an efficient vinylamine-containing polymer solution production process, consistent results, reduced waste, and a reliable product. This in turn leads to fewer issues in the papermaking processes and other applications in which vinylamine-containing polymer solutions are used.

The vinylamine-containing polymer solutions provided herein, produced through the methods disclosed herein, may be used in the manufacture of paper, board, or tissue, for example, as a strength aid, a dewatering aid, a coagulant, a flocculant, a retention agent, or a sizing promoter.

The following Examples are intended to illustrate the methods for producing vinylamine-containing polymer solutions as described herein, and are not to be viewed as limiting.

### EXAMPLES

### Example 1

To a 1-liter resin kettle equipped with overhead stirrer, thermocouple, condenser, nitrogen inlet-outlet, and pressure gauge was added 445 grams of deionized water, 1.2 grams of 75 wt % aqueous phosphoric acid, and 1.8 grams of 25 wt % aqueous sodium hydroxide. The resultant solution pH was adjusted to 6.5+/−0.3. The kettle was heated to 80° C. while stirring with overhead stirrer. The pressure was slowly lowered to about 320 torr.

N-vinylformamide (VFA, 90.4 grams), and 3.0 wt % aqueous V-50 (18.47 grams) initiator (available from Wako Chemicals USA, Inc., Richmond, USA) were added concurrently. The polymerization temperature was controlled at 78+/−2° C. After the V-50 addition was complete, the kettle vacuum was dropped to about 350 torr. After a total time of 260 minutes the vacuum was released, and the reactor was flushed with nitrogen (3 cycles of vacuum and nitrogen refill). After completion, the reactor was cooled to room temperature.

After the polymerization reaction was carried out, the resulting polyvinyl formamide polymer formulation was divided into eight parts and was spiked with a known concentration of N-vinylformamide monomer. The additional amount of unreacted N-vinylformamide monomers ranged from about 0.0 wt % to about 0.5 wt %, based on the total weight of the intermediate polymer formulation, as shown in Table 1 below.

After addition of the additional amount of unreacted N-vinylformamide monomers, each intermediate polymer formulation was subjected to alkaline hydrolysis reaction by adding 51 grams of 50% caustic solution. After 3 hours at 80° C., the reaction mixture was cooled to 40° C. and then 30 wt % aqueous hydrochloric acid was added over 5 minutes to adjust the pH to 9. Each of the resulting eight vinylamine-containing polymer solutions contained a polyvinylamine polymer.

The characteristics of each vinylamine-containing polymer solution were measured and observed as described below. The results are shown in Table 1.

TABLE 1
Characteristics of Vinylamine-Containing Polymers Based
on Intermediate Polymer Formulations with Varying Weight
Percentages of Unreacted N-vinylformamide Monomers

| Sample | VFA | Dynamic | |
|---|---|---|---|
| Number | (wt %) | Viscosity (cPs) | Color |
| 1 | 0.00 | 600 | Lightest Yellow |
| 2 | 0.05 | 672 | Light Yellow |
| 3 | 0.10 | 775 | Yellow |
| 4 | 0.20 | 1125 | Yellow |
| 5 | 0.25 | 1620 | Light Orange |
| 6 | 0.30 | Gelled | Orange |
| 7 | 0.40 | Gelled | Dark Orange |
| 8 | 0.50 | Gelled | Darkest Orange |

The dynamic viscosity of the vinylamine-containing polymer solution was measured with total solids of 18%, using a Brookfield viscometer at 6 rpm using an LV spindle number 62 at 25° C. The vinylamine-containing polymer solution was also visually monitored for occurrence of gelling. The color of each vinylamine-containing polymer solution was objectively determined by visual observation.

The results of this Example demonstrate the connection between the amount of unreacted N-vinylcarboxamide monomers in the intermediate polymer formulation and the characteristics (such as viscosity and color) of the vinylamine-containing polymer solution. In general, as the amount of unreacted N-vinylformamide monomers in the intermediate polymer formulation increases, the viscosity of the vinylamine-containing polymer solution increases, and the color of the vinylamine-containing polymer solution becomes darker (higher wavelength).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A method of synthesizing a vinylamine-containing polymer solution, the method comprising the steps of:
(a) reacting a polymerization initiator, one or more N-vinylcarboxamide monomers, and optionally one or more additional vinyl monomers having a formula different from the N-vinylcarboxamide monomers, in a reaction mixture to create an intermediate polymer formulation comprising a poly(N-vinylcarboxamide) prepolymer, wherein the N-vinylcarboxamide monomers have the general formula I 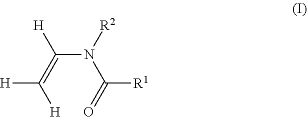
wherein R¹ and R², independently of one another, are H or C₁ to C₆ alkyl groups;
(b) hydrolyzing carboxamide groups in the poly(N-vinylcarboxamide) prepolymer to create a vinylamine-containing polymer solution comprising a vinyl-amine containing polymer;
(c) determining the intermediate polymer formulation to have an unacceptably high amount of unreacted N-vinylcarboxamide monomers;
(d) after step (c), modifying one or more process parameters of step (a); and
repeating step (a) after step (d) to form a modified intermediate polymer formulation.

2. The method of claim 1, further comprising:
(e) determining the amount of unreacted N-vinylcarboxamide monomers in the modified intermediate polymer formulation after repeating step (a) to be at or below a predetermined N-vinylcarboxamide threshold value.

3. The method of claim 1, wherein determining the intermediate polymer formulation to have an unacceptably high amount of unreacted N-vinylcarboxamide monomers comprises:
measuring the amount of unreacted N-vinylcarboxamide monomers in the intermediate polymer formulation;
comparing the amount of unreacted N-vinylcarboxamide monomers in the intermediate polymer formulation to a predetermined N-vinylcarboxamide threshold value; and
determining that the amount of unreacted N-vinylcarboxamide monomers in the intermediate polymer formulation is greater than the predetermined unreacted N-vinylcarboxamide threshold value.

4. The method of claim 3, wherein determining that the amount of unreacted N-vinylcarboxamide monomers is greater than the predetermined unreacted N-vinylcarboxamide threshold value comprises determining that the amount of unreacted N-vinylcarboxamide monomers is greater than about 0.03% by weight based on a total weight of the intermediate polymer formulation.

5. The method of claim 3, wherein determining that the amount of unreacted N-vinylcarboxamide monomers is greater than the predetermined unreacted N-vinylcarboxamide threshold value comprises determining that the amount of N-vinylcarboxamide monomers is greater than about 0.06% by weight based on a total weight of the intermediate polymer formulation.

6. The method of claim 1, wherein determining the intermediate polymer formulation to have an unacceptably high amount of unreacted N-vinylcarboxamide monomers comprises:
visually observing the color of the vinylamine-containing polymer solution after performing step (b); and
determining that the color of the vinylamine-containing polymer solution is dark yellow or higher wavelength in the electromagnetic spectrum.

7. The method of claim 1, wherein determining the intermediate polymer formulation to have an unacceptably high amount of unreacted N-vinylcarboxamide monomers comprises:
measuring the wavelength of the vinylamine-containing polymer solution; and
determining that the wavelength of the vinylamine-containing polymer solution is at least 600 nm using a spectrophotometer.

8. The method of claim 7, wherein the wavelength of the vinylamine-containing polymer solution is determined to be at least 575 nm.

9. The method of claim 1, wherein determining the intermediate polymer formulation to have an unacceptably high amount of unreacted N-vinylcarboxamide monomers comprises determining that a dynamic viscosity of the vinylamine-containing polymer solution exceeds a predetermined dynamic viscosity threshold value.

10. The method of claim 9, wherein determining that the dynamic viscosity of the vinylamine-containing polymer solution exceeds the predetermined dynamic viscosity threshold value comprises:
measuring the dynamic viscosity of the vinylamine-containing polymer solution, with total solids of 18%, using a Brookfield viscometer at 6 rpm using an LV spindle number 62 at 25° C.; and
determining that the dynamic viscosity of the vinylamine-containing polymer solution is greater than the predetermined dynamic viscosity threshold value.

11. The method of claim 10, wherein the predetermined dynamic viscosity threshold value is 700 cPs.

12. The method of claim 10, wherein the predetermined dynamic viscosity threshold value is 1100 cPs.

13. The method of claim 1, wherein the one or more process parameters of step (a) are chosen from the group of reaction time, temperature, pressure, pH, initiator concentration, monomer concentration, or purity of process water.

14. The method of claim 1, wherein hydrolyzing carboxamide groups in the poly(N-vinylcarboxamide) prepolymer to create a vinylamine-containing polymer solution comprises adding an acid or base to the reaction mixture.

15. The method of claim 1, wherein the polymerization initiator is an azo initiator.

16. The method of claim 3, wherein determining the intermediate polymer formulation to have an unacceptably high amount of unreacted vinylformamide monomers further comprises:
determining that the color of the vinylamine-containing polymer solution is visibly dark yellow or higher wavelength in the electromagnetic spectrum; and
determining that the dynamic viscosity of the vinylamine-containing polymer solution is greater than about 700 cPs.

17. A vinylamine-containing polymer solution formed by:
(a) reacting one or more N-vinylcarboxamide monomers and a polymerization initiator in a reaction mixture to create an intermediate polymer formulation comprising a poly(N-vinylcarboxamide) prepolymer, wherein the N-vinylcarboxamide monomers have the general formula I;
(b) optionally adding one or more vinyl monomers having a formula different from formula I during step (a);
(c) hydrolyzing carboxamide groups in the poly(N-vinylcarboxamide) prepolymer to create a vinylamine-containing polymer solution comprising a vinyl-amine containing polymer;
(d) determining the intermediate polymer formulation to have an unacceptably high amount of unreacted N-vinylcarboxamide monomers;
(e) modifying one or more process parameters of step (a);
(f) repeating step (a) to form a modified intermediate polymer formulation;
(g) determining the amount of unreacted N-vinylcarboxamide monomers in the modified intermediate polymer formulation;
(h) repeating steps (a) and (g) until the amount of unreacted N-vinylcarboxamide monomers in the modified intermediate polymer formulation is at or below a predetermined N-vinylcarboxamide threshold value.
